(19) United States
(12) Patent Application Publication
(10) Pub. No.: US 2006/0049599 A1
(43) Pub. Date: Mar. 9, 2006

(54) Inclinable vehicle

(76) Inventor: Sean Lehane, Frankston (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/514,344

(22) PCT Filed: May 24, 2002
(86) PCT No.: PCT/AU02/00650

§ 371 Date: Nov. 12, 2004

(30) Foreign Application Priority Data
Jun. 12, 2001 (AU) PR5606

(51) Int. Cl. B60G 1/04; B60G 9/00

(52) U.S. Cl. 280/124.11

(57) ABSTRACT

An inclinable all wheel drive vehicle with self-leveling chassis and self-locking capabilities, whether it is in motion or at rest, on level or laterally pitched ground. The vehicle has front and rear axle frames independently pivoted about a horizontal central chassis. An automatic tilt sensor controls hydraulics or motor to maintain vehicle's cabin level.

### FIELD OF INVENTION

The invention was brought about to rectify traditional vehicles inherent instability on steeply sloped and undulating terrain.

### BACKGROUND

Inclinable multi-wheeled vehicles are known with articulated suspensions, either by articulating the structure of the vehicle on an axle as described by French Patents 1 526 248 and 1 031 813 (P. Patin) or by a distortable parallelogram or trapezoid system as described in U.S. Pat. No. 3,418,098 (J. E Ward Jr.) or by the independent wheel and strut suspension as known in auto mobile technology and described in French Patents 828 405 (F. Maton and 1207 733 (K. J Lindbom), for example.

Such vehicles have dynamic stability like a two-wheeled vehicle but are not inherently stable when stationary; in fact when the vehicle is stationary a small lateral angular displacement away from the vertical will increase the torque produced by the spaced actions of the weight and the actions of the ground. This will increase the inclination of the vehicle; thus the center of gravity descends and the potential energy of the distortable system reduces as the vehicle inclines more.

### SUMMARY

The invention may provide in one aspect an all terrain self-leveling chassis/work platform that will handle lateral and longitudinal inclinations up to approximately 45° ground pitch whilst placing its weight evenly on four or more constantly vertical wheels.

In another aspect it may provide vehicle axles capable of handling the same or opposite inclinations of up to approx 45° lateral and/or longitudinal ground pitches.

In another aspect it may provide a chassis layout suitable to develop into a variety of multi wheeled vehicles.

In another aspect it may provide selectable all wheel drive and all wheel normal or opposed crab steering.

In its broadest aspect it provides a suspension for a vehicle comprising, at least two pairs of wheels,
an axle assembly for each pair of wheels, the axle assembly comprising upper and lower cam rods for each wheel joined by upper and lower pivot joints at their opposite ends to opposed intermediate members,
an axle member joined at its opposite ends to the opposed intermediate members by intermediate pivot joints located intermediate the upper and lower pivot joints,
a chassis assembly extending lengthwise between an adjacent pair of axle assemblies,
sensing means for sensing the inclination of the chassis assembly with respect to the horizontal across its width,
alignment means for moving the chassis assembly to lie generally horizontal across its width in response to signals from the sensing means, and
a tilt cam for each pair of wheels connected to each of the upper and lower cam rods by upper and lower pivotable tilt cam joints,
wherein the wheels are operatively connected to the intermediate members and the tilt cams are operatively connected to the chassis assembly such that alignment of the chassis assembly to the generally horizontal across its width results in the upper and lower cam rods, axle member and intermediate members aligning the wheels to assume a generally vertically directed configuration.

### BRIEF DESCRIPTION OF THE DRAWINGS

FIGS. 1-4 shows a chassis layout in plan, elevation and pitched elevation.

FIGS. 5-8 shows a tractor type cabin dotted on chassis as in FIGS. 1-4.

FIGS. 9 and 10 show the central cam and the operation of the pitch linkages. Note that hubs may be hydraulic drive or mechanically driven through the use of a differential or half shafts and universals.

FIG. 11 shows the relationship between the central chassis mounted cam shaft and the front and rear axle housings. The central chassis may carry a third axle across its centerline for six wheeled vehicle applications.

FIGS. 12 and 13 show the cam-lock and its relationship to the central chassis and the forward extension of the rear axle. These figures also show the operation of the cam-lock.

FIG. 14 shows the laser tilt-sensing unit.

FIG. 15 shows a steering box set up upon each of the four wheels with toe in adjustment hydraulic and lockable steering box.

### DETAILED DESCRIPTION OF THE PREFERRED EMBODIMENTS

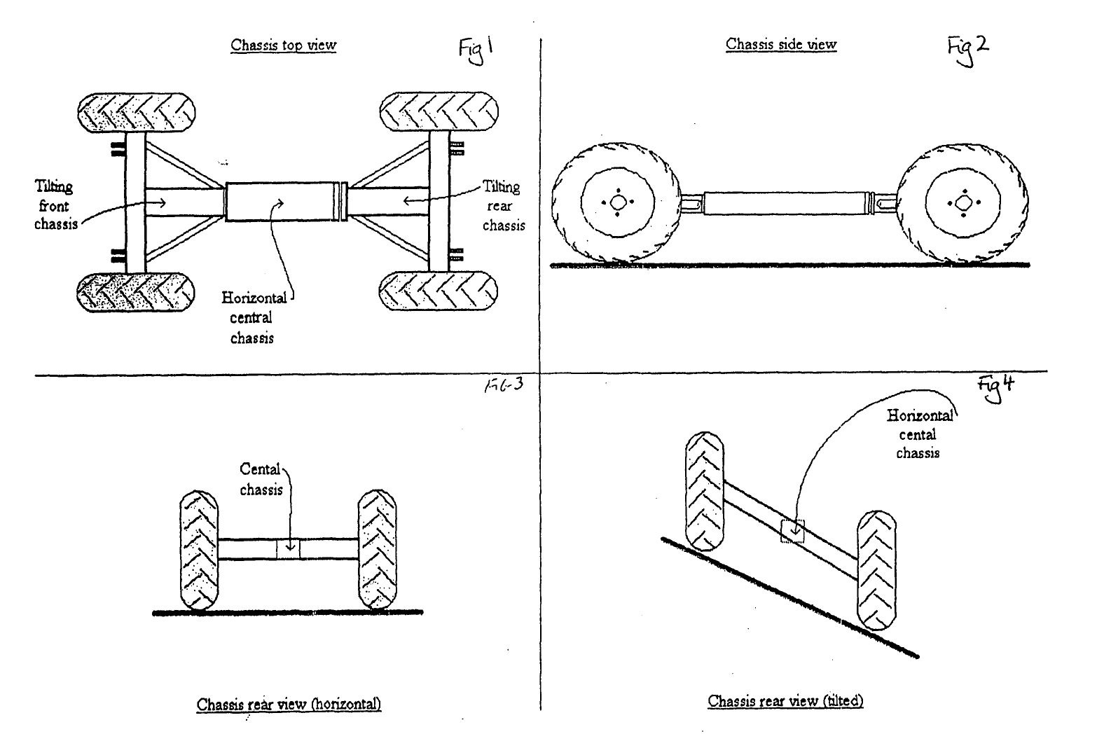

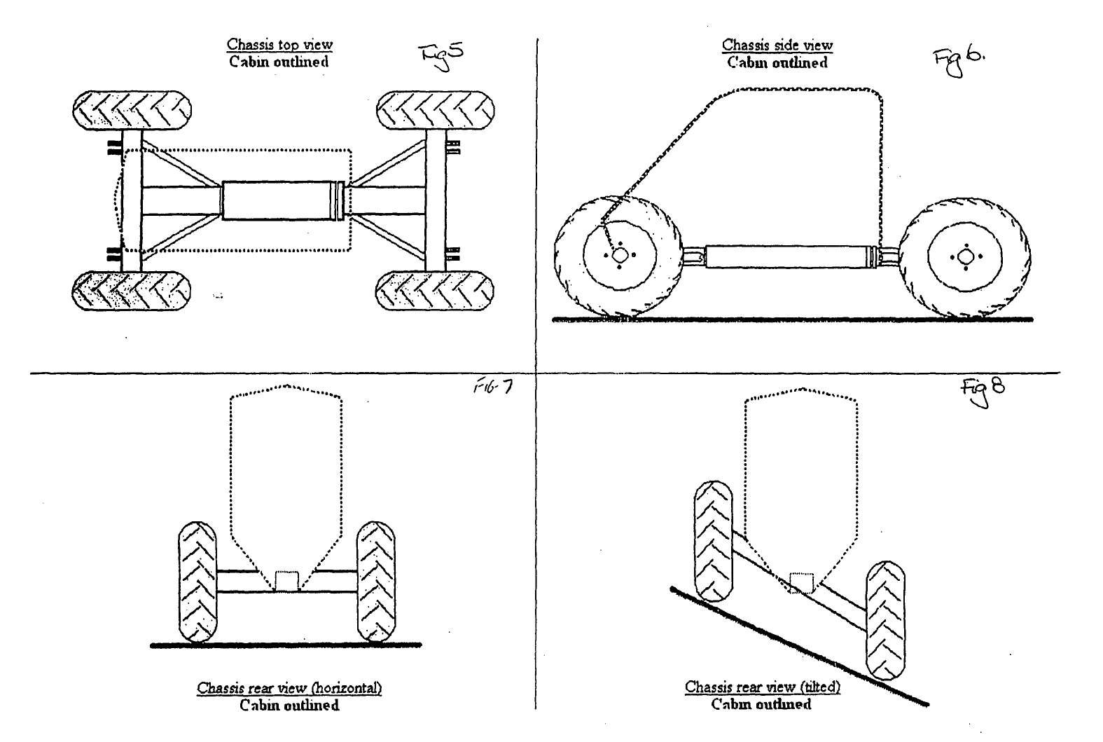

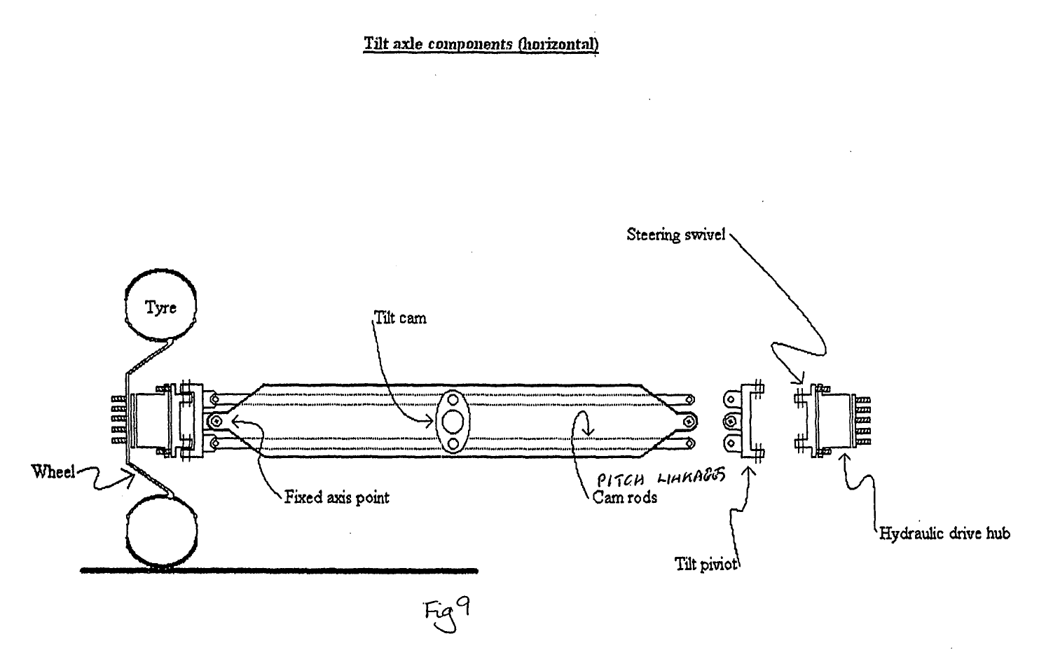

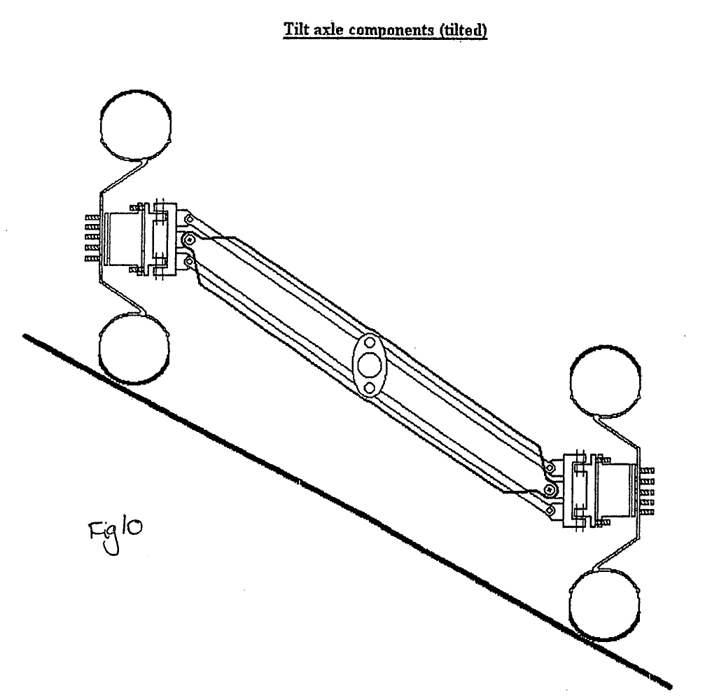

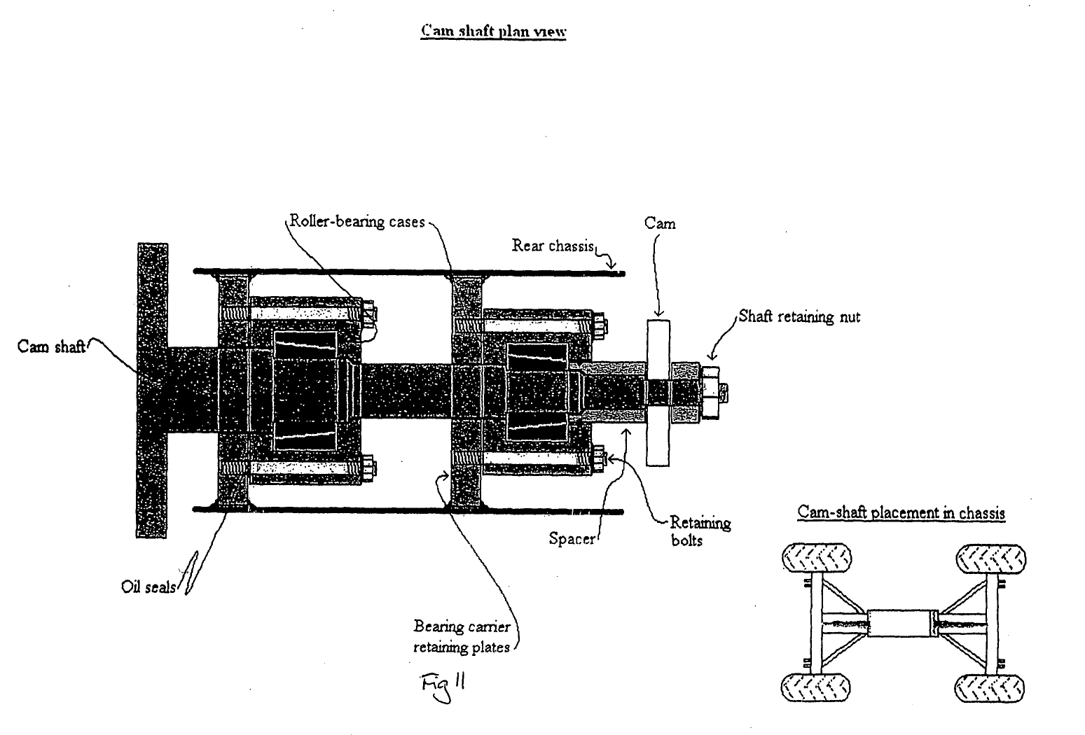

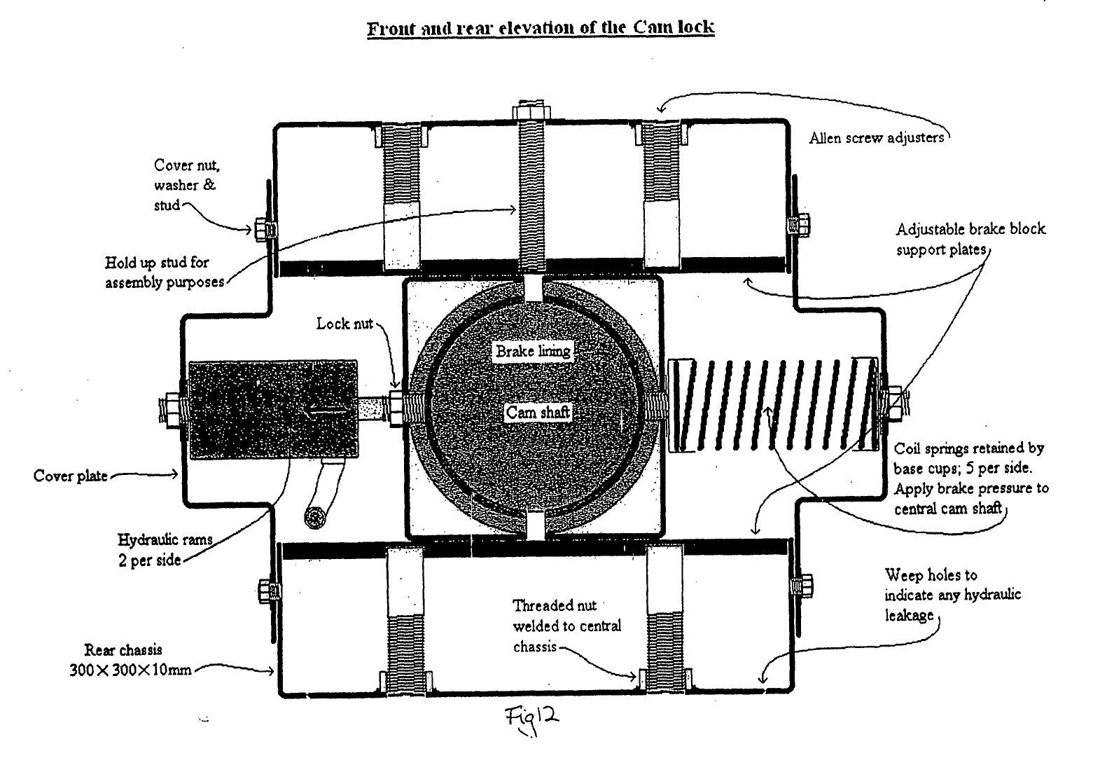

The present invention provides an inclinable multi-wheeled vehicle comprising a primary part and two or more similar secondary parts (FIGS. 1-4). The primary part supplying a central chassis/work platform on which to mount a cabin, power plant, equipment or load carrying structure and supplying the pivot points for the two or more secondary parts. The secondary parts are generally but not limited to the forward and rear axles which pivot about the central axis of the primary part and carry differentials, drive shafts, or hydraulic drive systems wheels brakes and steering components (FIG. 15).

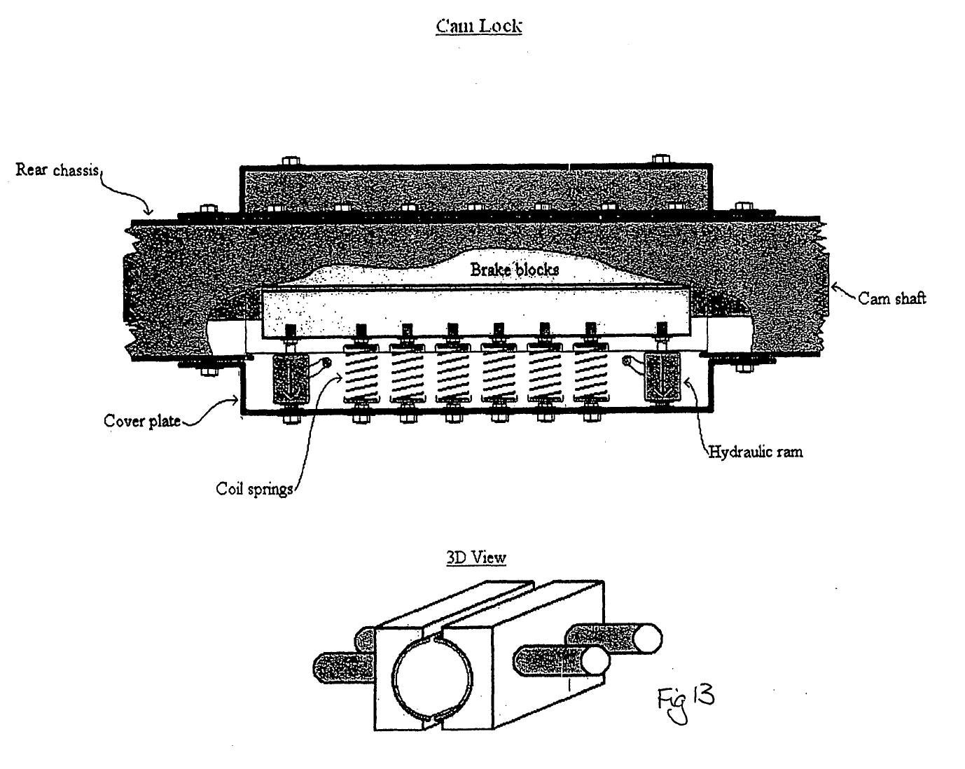

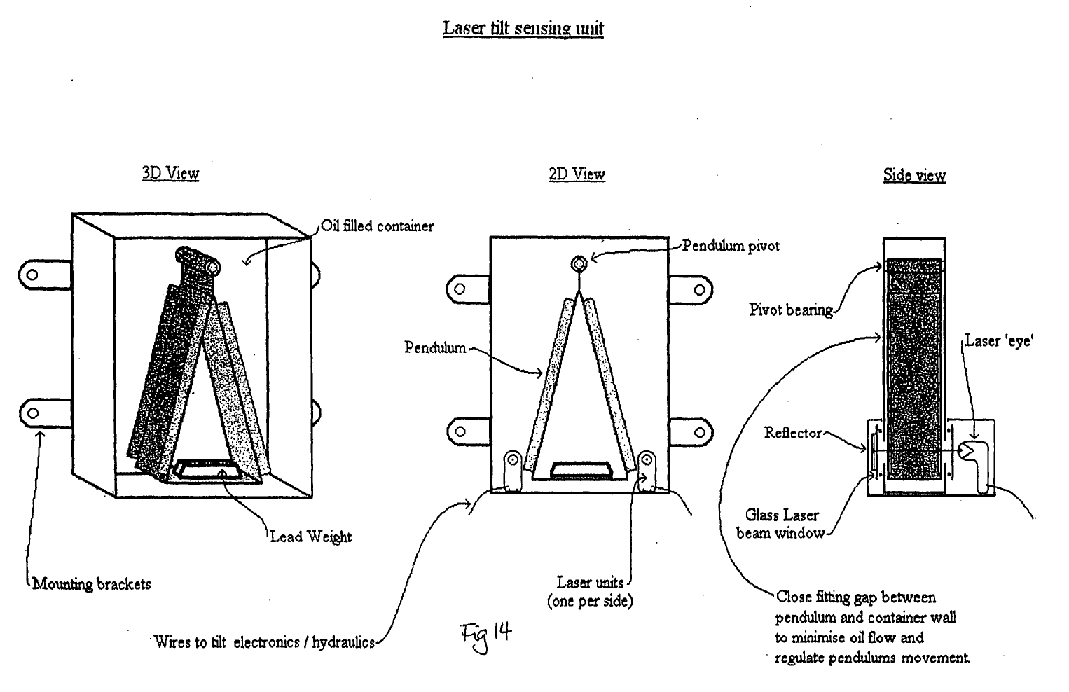

The two or more secondary parts or axles pivot independently to each other. The forward axle always follows the grounds contour. It contains a camshaft (FIG. 11) fixed to the primary part, which commands its internal pitch linkages to pitch its wheels vertically at all times (FIGS. 9 and 10).

The rear axle follows an independent ground contour, and as it starts to laterally pitch, it relays this pitch change to the central chassis which recognizes and mechanically adjusts back to level.

The rear axle is cam controlled by the primary or central chassis (as is the front axle) but also houses a cam lock (FIGS. 11 and 12) that locks the rotation of the primary parts about its axis. This lock is a positive mechanical lock that is only unlocked during a pitch trim adjustment.

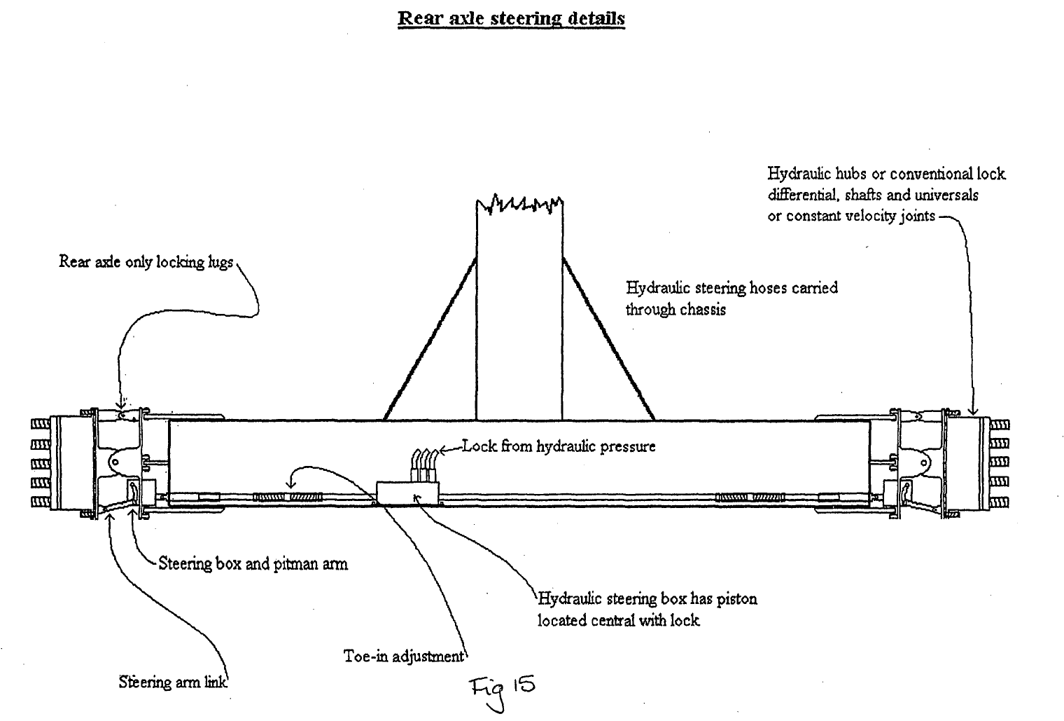

Pitch trim adjustment is by means of hydraulics or a motor that uses inputs to first unlock the cam-lock (FIGS. 12 and 13) and then to adjust pitch. When level lateral pitch of the central chassis is achieved the cam-lock relocks to the current lateral pitch of the rear axle. In a three-axle layout where the rear axle may be temporally unloaded, a load sensor will switch between central and rear axles as the moment requires.

The cam-lock device can be switched off during times of level or near level vehicle travel.

The torque capacity of the cam-lock is matched to the purpose and load carrying requirements of the particular vehicle.

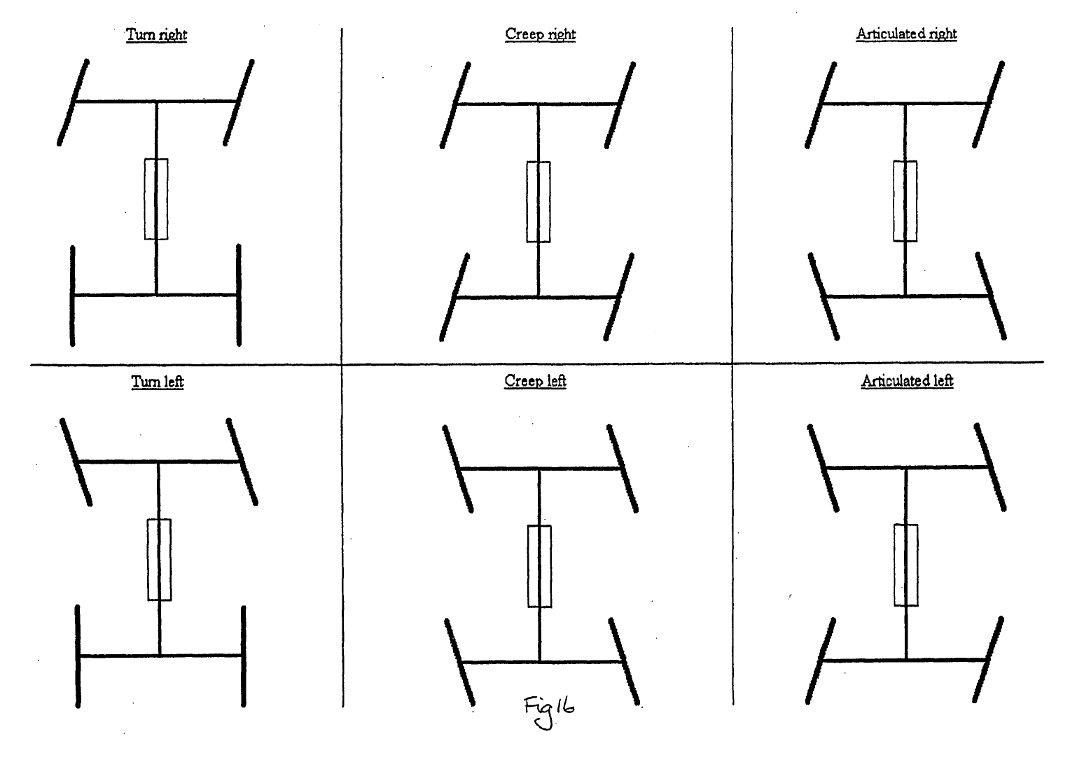

An automatic self-leveling sensor (FIG. 14) fixed to the central chassis commands the tilt hydraulics or motor to re-pitch the chassis back to level whenever any tilting is detected.

1. A suspension for a vehicle comprising,
at least two pairs of wheels,
an axle assembly for each pair of wheels, the axle assembly comprising upper and lower cam rods for each wheel joined by upper and lower pivot joints at their opposite ends to opposed intermediate members,
an axle member joined at its opposite ends to the opposed intermediate members by intermediate pivot joints located intermediate the upper and lower pivot joints,
a chassis assembly extending lengthwise between an adjacent pair of axle assemblies,
sensing means for sensing the inclination of the chassis assembly with respect to the horizontal across its width,
alignment means for moving the chassis assembly to lie generally horizontal across its width in response to signals from the sensing means, and
a tilt cam for each pair of wheels connected to each of the upper and lower cam rods by upper and lower pivotable tilt cam joints,
wherein the wheels are operatively connected to the intermediate members and the tilt cams are operatively connected to the chassis assembly such that alignment of the chassis assembly to the generally horizontal across its width results in the upper and lower cam rods, axle member and intermediate members aligning the wheels to assume a generally vertically directed configuration.

2. A suspension according to claim 1 comprising forward and rear cam shafts secured to the chassis assembly and to axle assemblies forward and rear of the chassis assembly, the forward and rear cam shafts acting to allow the forward and rear axle assemblies to pivot independently of each other.

3. A suspension according to claim 2 wherein one of the forward and rear cam shafts is rotatable about its longitudinal axis with respect to the chassis assembly and the chassis assembly comprises a cam lock for locking rotation of the rotatable cam with respect to the chassis assembly.

4. A suspension according to claim 3 wherein the cam lock is arranged to lock the rear cam shaft.

5. A suspension according to claim 1 wherein the alignment means comprises a motorised or hydraulically driven device.

6. A suspension according to claim 1 comprising a steering box set up for each of four of the wheels.

7. A suspension according to claim 1 comprising a pair of reinforcing members joining and extending between the chassis assembly and an axle assembly the reinforcing members being arranged to brace the axle assembly.

8. A vehicle comprising a cabin mounted on the chassis assembly of a suspension according to claim 1.

9. (canceled)
